(19) United States
(12) Patent Application Publication
(10) Pub. No.: US 2007/0131163 A1
(43) Pub. Date: Jun. 14, 2007

(54) DOCTOR BED

(76) Inventors: Christoph Henninger, Heidenheim (DE); Martin Schaubmaier, Rohrbach (AT); Michael Heitzinger, Linz (AT); Rudiger Keinberger, Aigen (AT); Horst Kaipf, Lauingen (DE)

Correspondence Address: TAYLOR & AUST, P.C., 142 SOUTH MAIN STREET, P. O. BOX 560, AVILLA, IN, 46710, US

(21) Appl. No.: 11/559,517

(22) Filed: Nov. 14, 2006

Related U.S. Application Data
(63) Continuation of application No. PCT/EP05/51640, filed on Apr. 14, 2005.

(30) Foreign Application Priority Data
May 14, 2004 (DE) DE 102004024079.5

(51) Int. Cl. B05C 11/02; B05C 3/02

(52) U.S. Cl. 118/100; 118/414; 118/123

(57) ABSTRACT

The invention relates to a doctor bed, formed as a profiled strip having a continuous groove in the axial direction to hold a rotatable metering rod, which can be pressed against a moving surface and meters and/or evens out liquid to pasty medium applied to the moving surface, the moving surface in the case of direct application of the medium being one side of a paper, board or other fibrous web and in the case of indirect application being the surface of a transfer element which transfers the medium to the fibrous web.

### CROSS REFERENCE TO RELATED APPLICATIONS

This is a continuation of PCT application No. PCT/EP2005/051640, entitled “DOCTOR BED”, filed Apr. 14, 2005.

### BACKGROUND OF THE INVENTION

1. Field of the Invention

The invention relates to a doctor bed, formed as a profiled strip having a continuous groove in the axial direction to hold a rotatable metering rod, which can be pressed against a moving surface and meters and/or evens out liquid to pasty medium applied to the moving surface, the moving surface in the case of direct application of the medium being one side of a paper, board or other fibrous web and in the case of indirect application being the surface of a transfer element which transfers the medium to the fibrous web.

2. Description of the Related Art

Doctor beds are used to mount and support circularly cylindrical metering rods which are used for metering and/or evening out a liquid to pasty medium applied to a moving base within what are known as coating machines. The metering rods are normally produced from a homogeneous material. In this case, very long and slim cylindrical metering rods have to be held at low to high rotational speeds while these apply, wipe off or merely distribute the coating material as uniformly as possible. The use of such metering rods is subject to wear. Changing the very expensive rods is then associated with expenditure on work and operating interruption. In addition, the doctor beds have to be renewed regularly on account of wear. The service life of the doctor bed, which is intended to press on the rod highly accurately and uniformly over its entire length, is thus limited. To this end, the doctor bed needs inherent elasticity and, at the same time, the best possible ability to slide and resistance to abrasion. The doctor bed is normally loaded with water under appropriate pressure via internal channels or profiled chambers, so that the metering rod is given a floating mounting in the doctor bed. In particular, modern metering rods provided with profiling, which create improved application metering, especially wear out the doctor beds in regions with a high supporting pressure.

DE 101 20 786 A1 discloses a doctor bed for pressing a rotating metering rod against a roll, such as an applicator roll or coating roll in paper machines, the doctor bed being formed as a profiled strip which supports the metering rod elastically in the pressing direction. The doctor bed consists of an elastomer polyurethane material which is mixed with a proportion of at least 3 percent by weight of an ultra high molecular weight polyethylene. As a result of the admixture of an ultra high molecular weight polyethylene, longer service lives in terms of the ability to slide and abrasion resistance are intended to be achieved.

Furthermore, in DE 43 34 555 A1 a description is given of a holder for a metering rod which has a doctor bed holding the metering rod, which doctor bed is mounted such that it can move in the direction of the holder opening in a holder open on one side. Arranged between holder and doctor bed is an elastic pressure hose pressing in the direction of the holder opening. In order to be able to set a gap between metering rod and a roll which is precise in terms of its width and uniform over the working width, a further pressure hose pressing in the opposite direction is provided. By means of the respective loading of the pressure hoses, the intention is for the transverse profile to be set independently of the pressing pressure with a finely adjustable profiling device.

However, in the solutions proposed, zonally different wear phenomena occur over the entire length of a doctor device or constitute solutions which, although controllable, are technically very complicated with respect to the pressing pressure.

Furthermore, in the case of uneven loading, problems can result from increased wear beginning as a result of partial deformation, for example in the edge region of the paper web, on account of inadequate lubrication, fiber deposits from the edge of the paper web, unfavorable frictional conditions in the transition from coating material to the edge wetting or partial dry running.

What is needed in the art is a doctor bed which exhibits uniform wear in the wear behavior over its entire length.

### SUMMARY OF THE INVENTION

According to the invention, a doctor bed is provided, formed as a profiled strip having a continuous groove in the axial direction, to support a metering rod in the pressing direction, the doctor bed being formed in some sections in the axial direction by at least one insert part which has a more stable shape in relation to the remaining material.

The present invention provides a relatively short component, which in each case is inserted in the critical region and preserves the inherent elasticity of the entire doctor device which is required for operation.

As a result of the corresponding inherent elasticity, a metering rod arranged in the groove is supported flexibly in the pressing direction, that is to say in the direction of the moving base to be coated, for example an applicator roll of a coating machine. An insert part or a plurality of insert parts is or are incorporated in the doctor bed and arranged along the axial direction in particular at points at which particularly high wear occurs in the case of conventional doctor beds. A particular advantage is the low abrasion or wear achieved by the present invention and a low coefficient of friction of the materials used, which lead to an increased service life of the doctor bed.

In this case, there can be a plurality of critical zones with increased wear. A particular advantage of the invention results from the use of the materials coordinated with one another in terms of wear behavior, for example with resilient materials as a base material in conjunction with appropriately stable-shape and wear-resistant insert parts. Therefore, the doctor bed exhibits uniform wear in the wear behavior over its entire length. For an insert part—also designated as insert—heat-resistant, stable-shape, abrasion-resistant and low-friction materials coordinated with one another are beneficially suitable.

One advantageous refinement of the invention provides for there to be a plurality of insert parts in the external region in the axial direction. However, it is also possible for only one insert part to be arranged, in the center and/or are arranged in the center. To some extent, therefore, an insert part is arranged in a critical region in order to compensate for partial deformation, for example in the edge region of a paper web, on account of inadequate lubrication, fiber deposits or unfavorable frictional conditions. In this way, the problems mentioned at the beginning which result from unequal loading are rectified.

A particular role is also played by the transitions of the individual material combinations which, in the base material of the doctor bed and an insert part, can exhibit highly different mechanical characteristics. In an embodiment of the present invention, by way of the component geometry of the respective insert part, a homogeneous transition between the materials used for an insert part and the remaining profiled strip is formed. In this way, a homogeneous and gentle transition between different materials can be created.

Advantageously, the common contact surfaces of the respective insert part with the surrounding material are arranged substantially at an angle of 45°-90°, preferably 70°-90°, with respect to the axial direction. This arrangement results in a more homogeneous transition between the different materials. In this connection, substantially means that, for geometric reasons, other surface orientations can of course also occur in the constructional design of the insert parts. However, these orientations should have a subordinate influence on the elasticity of the doctor bed and in particular on the nature of a smooth transition of the introduction of force to a metering rod.

During the application of a liquid or pasty medium, for example to a moving material web of paper or board, considerable temperatures can occur, which can also impair the function of doctor devices. To this end, in an embodiment of the present invention, the respective insert part is heat-resistant.

For example, in the case of rolling doctor devices, the doctor beds perform the guiding and supporting function for the rotatably mounted metering rods. These should be guided by material which can slide as easily as possible but which is intended to meet still further requirements with respect to adequately long service lives of the device. To this end, in an embodiment of the present invention, the respective insert part is wear-resistant.

The respective insert part advantageously includes thermoplastic. Advantageous in particular is an insert part of polyethylene (PE) or high-strength polyether ether ketone (PEEK) because of a correspondingly high ductility of the materials. In this way, in relation to the remaining base material, a homogeneous transition over the entire length of the doctor bed with respect to the elasticity of the doctor bed is already created by the material selection. However, the thermoplastic is selected in such a way that the latter nevertheless remains more rigid than the base material when heated.

Alternatively, the respective insert part can also advantageously include polymers, for example of polyurethane (PU) or polyamide (PA). Suitable for this purpose in particular is the elastomer such as polyurethane (PU) since it can be resilient to hard in terms of its mechanical characteristics and is abrasion-resistant at the same time. On the other hand, apart from its abrasion resistance, polyamide (PA) is comparatively hard.

Alternatively, the respective insert part can advantageously include a material composite. In particular, the insert part can advantageously be formed from a material composite comprising rubber and graphite.

Alternatively, the respective insert part can advantageously also include ceramic. In this way, a particularly stable-shape and wear-resistant insert part is created in the doctor bed.

Alternatively, the respective insert part can advantageously also include metal. Metals made of a copper alloy, for example of bronze, are particularly well suited for this purpose. Bronze as a material is also distinguished as particularly corrosion-resistant.

In another embodiment of the present invention, the respective insert part is form-fitting, adhesively bonded, screwed, riveted, pressed in, cast in or welded in. Depending on the area of use, the respectively beneficial joining method can be chosen with regard to the mechanical loading of the doctor bed during operation.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of a doctor bed with insert part at the edge;

FIG. 2 is a perspective view of a doctor bed with a centrally arranged insert part; and

FIG. 3 is a perspective view of a doctor bed with an insert part held by a form fit.

Corresponding reference characters indicate corresponding parts throughout the several views. The exemplifications set out herein illustrate embodiments of the invention, in one form, and such exemplifications are not to be construed as limiting the scope of the invention in any manner.

### DETAILED DESCRIPTION OF THE INVENTION

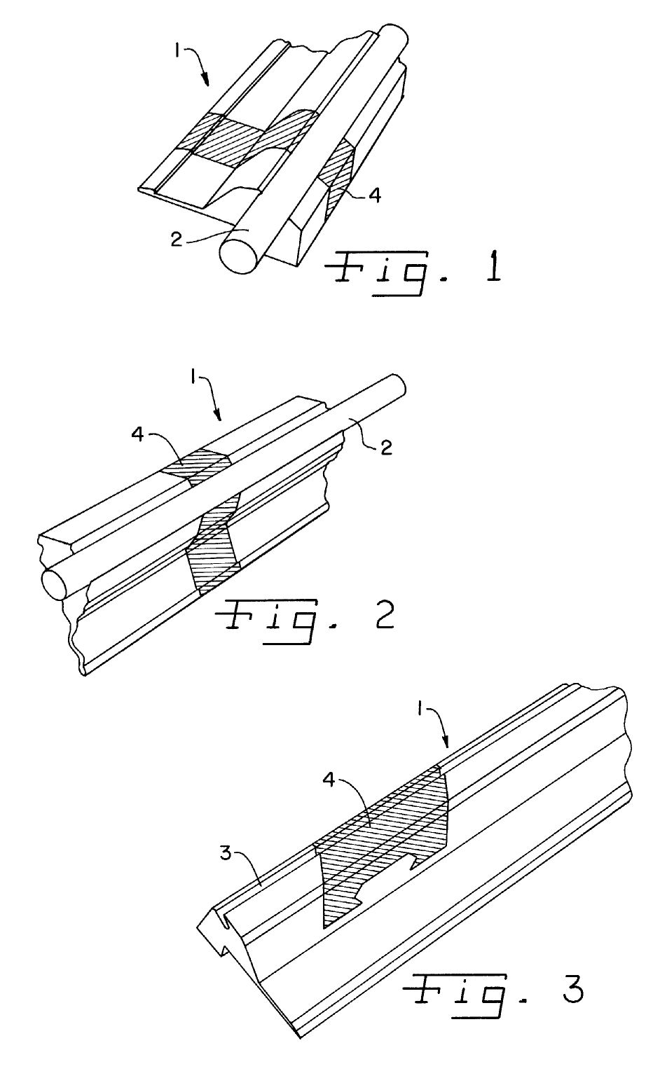

Referring now to the drawings, and more particularly to FIG. 1, there is shown a doctor device according to the invention having a doctor bed 1 and a metering rod 2 with an insert part 4 arranged in the edge region. The metering rod 2 is rotatably mounted in the groove 3 running axially in the doctor bed 1. In order to support a metering rod 2 in the pressing direction, a relatively short insert part 4 is arranged in the profiled strip, as seen in the axial direction, in order to preserve the necessary inherent elasticity of the entire doctor device. In this case, the component extends over the entire width of the doctor bed 1.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### List of Designations

1. Doctor bed
2. Metering rod
3. Groove
4. Insert part

What is claimed is:

1. A doctor bed configured to hold a rotatable metering rod to press against a moving surface and to at least one of meter and even out a liquid to pasty medium applied to the moving surface, the moving surface being one side of a fibrous web when the medium is directly applied to the moving surface, the moving surface being a surface of a transfer element which transfers the medium to the fibrous web when the medium is indirectly applied to the moving surface, said doctor bed comprising:
a profiled strip having a continuous groove in an axial direction of the doctor bed, said groove configured to hold the rotatable metering rod, the doctor bed having a plurality of sections in said axial direction and formed in some of said plurality of sections by at least one insert part being at least one of more wear-resistant and more heat-resistant in relation to a material of a remaining said profiled strip.

2. The doctor bed of claim 1, wherein the doctor bed includes a center in said axial direction and an external region in said axial direction, said at least one insert part including a plurality of insert parts, one of one said insert part arranged in said center and said plurality of insert parts arranged in at least one of said external region and said center.

3. The doctor bed of claim 1, wherein said at least one insert part includes a component geometry configured for having a homogeneous transition between a material used for said insert part and said material used for said remaining profiled strip.

4. The doctor bed of claim 3, wherein said at least one insert part includes a plurality of common contact surfaces with a surrounding material of said profiled strip, said common contact surfaces arranged substantially at an angle of 45°-90° with respect to said axial direction.

5. The doctor bed of claim 3, wherein said at least one insert part includes a plurality of common contact surfaces with a surrounding material of said profiled strip, said common contact surfaces arranged substantially at an angle of 70°-90° with respect to said axial direction.

6. The doctor bed of claim 1, wherein said at least one insert part has a high capacity to slide.

7. The doctor bed of claim 1, wherein said at least one insert part has a stabler shape.

8. The doctor bed of claim 1, wherein said at least one insert part includes a plurality of thermoplastics.

9. The doctor bed of claim 8, wherein said at least one insert part includes one of a polyethylene and a high-strength polyether ether ketone.

10. The doctor bed of claim 1, wherein said at least one insert part includes one of a polyurethane and a polyamide.

11. The doctor bed of claim 1, wherein said at least one insert part includes a material composite.

12. The doctor bed of claim 11, wherein said material composite of said insert part comprises a rubber and a graphite.

13. The doctor bed of claim 1, wherein said at least one insert part includes a ceramic.

14. The doctor bed of claim 1, wherein said at least one insert part includes a metal.

15. The doctor bed of claim 14, wherein said at least one insert part includes a copper alloy.

16. The doctor bed of claim 14, wherein said at least one insert part includes a bronze.

17. The doctor bed of claim 1, wherein said at least one insert part is one of form-fitting, adhesively bonded, screwed, riveted, pressed in, cast in, or welded in.
